(19) United States
(12) Patent Application Publication
(10) Pub. No.: US 2014/0022313 A1
(43) Pub. Date: Jan. 23, 2014

(54) LIQUID DISPENSER INCLUDING ASYMMETRIC NOZZLE ACTUATOR CONFIGURATION

(71) Applicants: Zhanjun Gao, Rochester, NY (US); Yonglin Xie, (US)

(72) Inventors: Zhanjun Gao, Rochester, NY (US); Yonglin Xie, (US)

(21) Appl. No.: 13/552,763

(22) Filed: Jul. 19, 2012

(51) Int. Cl. B41J 2/05

(52) U.S. Cl. 347/61

(57) ABSTRACT

A liquid dispenser includes first and second liquid chambers. The first chamber includes a nozzle having a center axis. The second chamber is in fluid communication with liquid supply and return channels. A flexible membrane separates and fluidically seals the first and second chamber. A heater, associated with the second chamber, includes a center point and is selectively actuated to create a pressure pulse in a liquid that causes the flexible membrane to move from a first position to a second position to eject liquid through the nozzle of the first chamber. The center point of the heater is located off of the center axis of the nozzle. In one embodiment, a liquid supply provides a liquid that flows continuously from the supply through the liquid supply channel through the second chamber through the liquid return channel and back to the supply during a drop dispensing operation.

### CROSS REFERENCE TO RELATED APPLICATIONS

Reference is made to commonly-assigned, U.S. patent applications Ser. No. ______ (Docket K001109), entitled “LIQUID DISPENSER INCLUDING ACTIVE MEMBRANE ACTUATOR”, Ser. No. ______ (Docket K001110), entitled “LIQUID DISPENSER INCLUDING PASSIVE PRE-STRESSED FLEXIBLE MEMBRANE”, all filed concurrently herewith.

### FIELD OF THE INVENTION

This invention relates generally to the field of digitally controlled liquid dispensing devices and, in particular, to liquid dispensing devices that include a flexible membrane.

### BACKGROUND OF THE INVENTION

Ink jet printing has become recognized as a prominent contender in the digitally controlled, electronic printing arena because of its non-impact, low-noise characteristics, its use of plain paper, and its avoidance of toner transfer and fixing. Ink jet printing mechanisms can be categorized by technology as either drop on demand ink jet (DOD) or continuous ink jet (CU).

Continuous inkjet printing uses a pressurized liquid source that produces a stream of drops some of which are selected to contact a print media (often referred to a “print drops”) while other are selected to be collected and either recycled or discarded (often referred to as “non-print drops”). For example, when no print is desired, the drops are deflected into a capturing mechanism (commonly referred to as a catcher, interceptor, or gutter) and either recycled or discarded. When printing is desired, the drops are not deflected and allowed to strike a print media. Alternatively, deflected drops can be allowed to strike the print media, while non-deflected drops are collected in the capturing mechanism.

Drop on demand printing only provides drops (often referred to a “print drops”) for impact upon a print media. Selective activation of an actuator causes the formation and ejection of a drop that strikes the print media. The formation of printed images is achieved by controlling the individual formation of drops. Typically, one of two types of actuators is used in drop on demand printing devices—heat actuators and piezoelectric actuators. When a piezoelectric actuator is used, an electric field is applied to a piezoelectric material possessing properties causing a wall of a liquid chamber adjacent to a nozzle to be displaced, thereby producing a pumping action that causes an ink droplet to be expelled. When a heat actuator is used, a heater, placed at a convenient location adjacent to the nozzle, heats the ink. Typically, this causes a quantity of ink to phase change into a gaseous steam bubble that displaces the ink in the ink chamber sufficiently for an ink droplet to be expelled through a nozzle of the ink chamber.

In some applications it may be desirable to use an ink that is not aqueous and, as such, does not easily form a vapor bubble under the action of the heater. Heating some inks may cause deterioration of the ink properties, which can cause reliability and quality issues. As described in U.S. Pat. No. 4,480,259 and U.S. Pat. No. 6,705,716, one solution is to have two fluids in the print head with one fluid dedicated to respond to an actuator, for example, to create a vapor bubble upon heating, while the other fluid is the ink. The performance capabilities of these types of print heads are often limited due to the resistance of the membrane or diaphragm that separates the actuator fluid from the ink which reduces the amount of volumetric displacement that occurs in ink chamber as a result of the pressure caused by the vaporization of the actuator fluid. Although U.S. Pat. No. 4,480,259 and U.S. Pat. No. 6,705,716 both describe flexible diaphragms, it is well understood by one skilled in the art that it is difficult to manufacture a micro-fluidics device such as an ink jet print head using conventional MEMS technology while incorporating a sufficiently elastic material for use as a diaphragm. Additionally, repeated cycles of stretch and relax cause material fatigue in the diaphragm resulting in reduced device reliability and poor device performance.

As such, there is an ongoing effort to increase the reliability and performance of print heads that include two fluids and a flexible membrane.

### SUMMARY OF THE INVENTION

According to an aspect of the present invention, a liquid dispenser includes a first liquid chamber and a second liquid chamber. The first liquid chamber includes a nozzle. The nozzle includes a center axis. A liquid supply channel is in fluid communication with the second chamber. A liquid return channel is in fluid communication with the second chamber. A flexible membrane is positioned to separate and fluidically seal the first liquid chamber and the second liquid chamber from each other. A heater, associated with the second liquid chamber, is selectively actuated to create a pressure pulse in the liquid that causes the flexible membrane to move from a first position to a second position to eject liquid through the nozzle of the first liquid chamber. The heater includes a center point that is located off of the center axis of the nozzle. In one embodiment, a liquid supply provides a liquid that flows continuously from the supply through the liquid supply channel through the second chamber through the liquid return channel and back to the supply during a drop dispensing operation.

According to another aspect of the present invention, a method of printing includes providing a liquid dispenser made in accordance with the invention described herein and using it to dispense liquid drops.

In one example embodiment of the invention, the liquid in the second liquid chamber is different from the liquid in the first chamber. Commonly referred to as a working fluid, the liquid in the second chamber has different characteristics when compared to the liquid in the first liquid chamber. For example, the working fluid can have a lower boiling point when compared to first liquid. The working fluid can also be a non-corrosive liquid such as a nonionic liquid.

In one example embodiment of the invention, a center point of the flexible membrane is located on the center axis of the nozzle. The flexible membrane can be corrugated. Alternatively, the flexible membrane can be under a compressive pre-stress such that it resides in a first position or location but switches to a second position or location using a snap-through motion when lateral force is applied on the flexible membrane.

In one example embodiment of the invention, the heater is a bubble jet type heater that creates the pressure pulse by vaporizing a portion of the liquid in the second chamber. The heater can include a split heater structure or configuration.

### BRIEF DESCRIPTION OF THE DRAWINGS

In the detailed description of the example embodiments of the invention presented below, reference is made to the accompanying drawings, in which:

FIG. 1 is a schematic cross sectional view of an example embodiment of a liquid dispenser made in accordance with the present invention;

FIG. 2 is a schematic cross sectional view of the example embodiment shown in FIG. 1 in an actuated state;

FIG. 3 is a schematic top view of an example embodiment of a heater included in an example embodiment of a liquid dispenser made in accordance with the present invention;

FIG. 4 is a schematic cross sectional view of another example embodiment of a liquid dispenser made in accordance with the present invention; and

FIG. 5 is a schematic cross sectional view of another example embodiment of a liquid dispenser made in accordance with the present invention.

### DETAILED DESCRIPTION OF THE INVENTION

The present description will be directed in particular to elements forming part of, or cooperating more directly with, apparatus in accordance with the present invention. It is to be understood that elements not specifically shown or described may take various forms well known to those skilled in the art. In the following description and drawings, identical reference numerals have been used, where possible, to designate identical elements.

The example embodiments of the present invention are illustrated schematically and not to scale for the sake of clarity. One of the ordinary skills in the art will be able to readily determine the specific size and interconnections of the elements of the example embodiments of the present invention.

As described herein, the example embodiments of the present invention provide a liquid dispenser, often referred to as a print head, which is particularly useful in digitally controlled inkjet printing devices in which drops of ink are ejected from a print head toward a print medium. However, many other applications are emerging which use liquid dispensers, similar to inkjet print heads, to emit liquids, other than inks, that need to be finely metered and deposited with high spatial precision. As such, as described herein, the terms “liquid” and “ink” are used interchangeably and refer to any material, not just inkjet inks, which can be ejected by the example embodiments of the liquid dispenser described below.

In addition to inkjet printing applications in which the fluid typically includes a colorant for printing an image, the liquid dispenser of the present invention is also advantageously used in ejecting other types of fluidic materials. Such materials include functional materials for fabricating devices (including conductors, resistors, insulators, magnetic materials, and the like), structural materials for forming three-dimensional structures, biological materials, and various chemicals. The liquid dispenser of the present invention provides sufficient force to eject fluids having a higher viscosity than typical inkjet inks, and does not impart excessive heat into the fluids that could damage the fluids or change their properties undesirably.

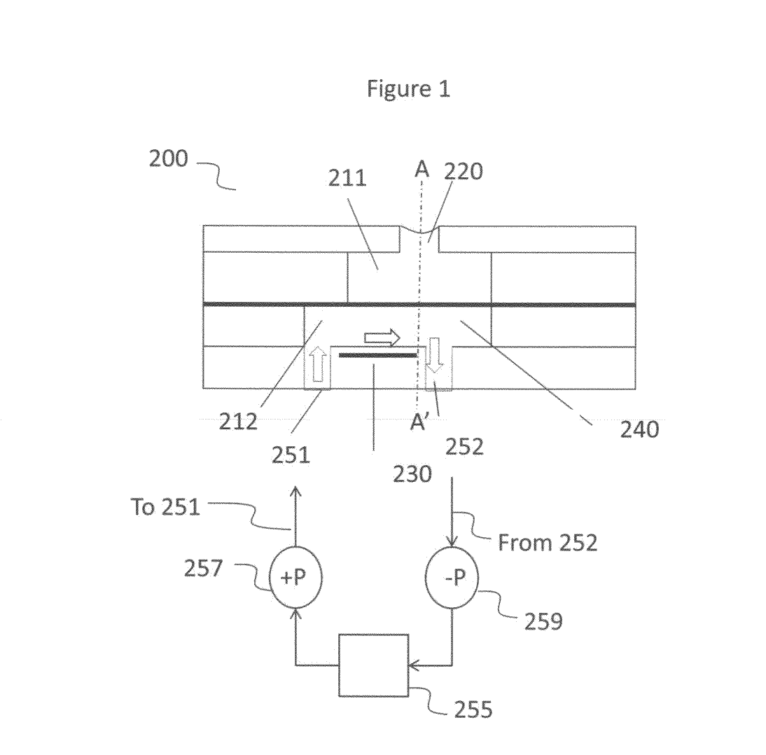

Referring to FIG. 1, a liquid dispenser 200 including a membrane MEMS actuator is shown. Liquid dispenser 200 includes a first liquid chamber 211 and a second liquid chamber 212. First liquid chamber 211 includes a nozzle 220. A flexible membrane 240 is positioned in liquid dispenser 200 to separate and fluidically seal the first liquid chamber 211 and the second liquid chamber 212 from each other. A center axis A-A′ extends through the center of nozzle 220. As shown in FIG. 1, flexible membrane 240 that includes no corrugation when flexible membrane 240 is in an unactuated position or state (often referred to as an at rest position or state). In this sense, flexible membrane is flat. The overall shape of flexible membrane 240 is planar when viewed from end to end of flexible membrane 240. The overall shape of flexible membrane 240 is symmetric relative to a center axis A-A′ when viewed, as shown in FIG. 1, from end to end of flexible membrane 240.

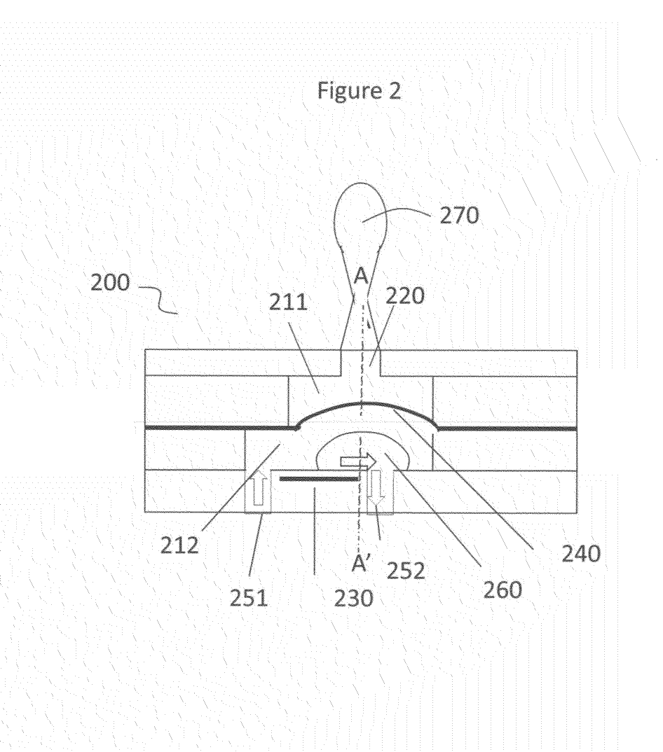

Liquid dispenser 200 includes a selectively actuatable thermal actuator that uses heat energy to divert a portion a liquid (often referred to as a first liquid) located in first liquid chamber 211 through nozzle 220. The thermal actuator includes a heater in one example embodiment of the invention that is commonly referred to as a “bubble jet” heater. When selectively actuated, the heat generated by this type of thermal actuator vaporizes a portion of a liquid (often referred to as a second liquid) in the vicinity of the actuator creating a vapor bubble 260 (shown in FIG. 2) which causes the first liquid to the ejected through nozzle 220.

Referring back to FIG. 1, a heater 230 is associated with second liquid chamber 212. Heater 230 is located in a wall of the second liquid chamber 212 opposite flexible membrane 240. As shown in FIG. 1, heater 230 is a “bubble jet” type heater. Again, center axis A-A′ extends through the center of nozzle 220. Nozzle 220 includes a center point, heater 230 includes a center point, and flexible membrane 240 includes a center point. As shown in FIG. 1, the center point of heater 230 is located off of center axis A-A′. Flexible membrane 240 resides at an initial equilibrium position when heater 230 is not energized. The sizes or shapes of first chamber 211 and second chamber 212 can vary in example embodiments of the invention, provided the center points of heater 230 and nozzle 220 are offset relative to center axis A-A′ of nozzle 220. As shown in FIG. 1, the center points of nozzle 220 and flexible membrane 240 are collinear relative to each other and are located along center axis A-A′ that extends through the center of nozzle 220.

First chamber 211 is adapted to receive a liquid that is supplied to first chamber 211 in a conventional manner. Second chamber 212 is adapted to receive a liquid that is supplied to second chamber 212 in a conventional manner or in a manner according to one aspect of the present invention (described in more detail below). As flexible membrane 240 fluidically seals first chamber 211 and second chamber 212 from each other, first chamber 211 and second chamber 212 are physically distinct from each other which allows the first liquid and the second liquid present in each respective chamber to be different types of liquid when compared to each other in example embodiments of the invention.

Referring to FIG. 2, a portion of a liquid (often referred to as a second liquid) located in second liquid chamber 212 is vaporized, forming a vapor bubble 260, when electric energy is applied to heater 230. The pressure resulting from the expanding vapor bubble 260 pushes flexible membrane 240 toward nozzle 220 (up as shown in FIG. 2) and causes flexible membrane 240 to bend, for example, snap-through, to another equilibrium position. This can also be referred to as an actuated position or state of flexible membrane 240. The displacement of the flexible membrane 240 pressurizes a liquid (often referred to as a first liquid) located in first liquid chamber 211 causing a liquid drop 270 to be ejected through nozzle 220.

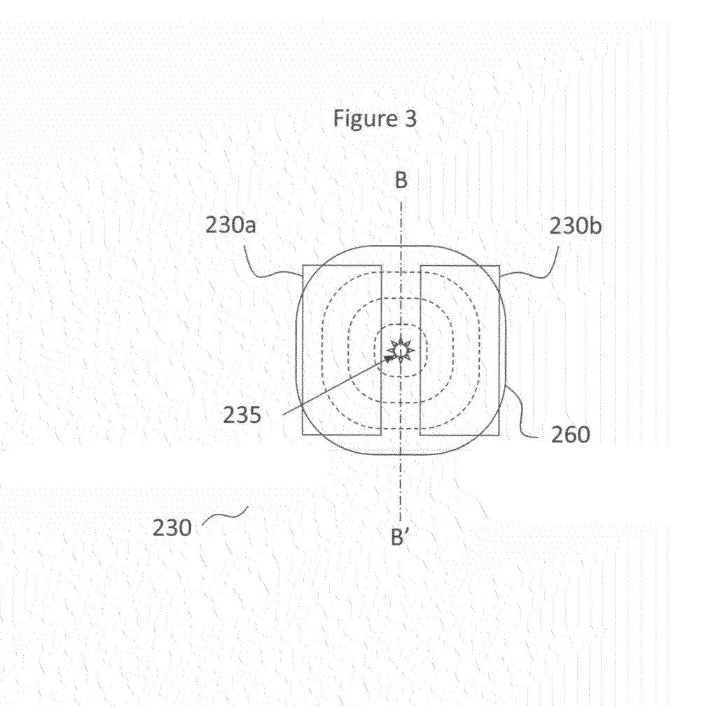

Referring to FIG. 3, heater 230 includes a split heater structure as viewed along the direction of center axis A-A′ (in FIG. 3 center axis A-A′ extends into and out of the figure). The split heater 230 includes two halves 230a and 230b symmetrically positioned relative to a plane B-B′ that includes the center point 235 of the heater 230. Vapor bubble 260 is shown in FIG. 3 as concentric rings (using dashed lines). The split heater configuration allows vapor bubble 260 to collapse at the center point 235 of the heater 230, reducing or even avoiding cavitation damage to the heater. Other heater 230 structures or configurations can be included in alternative example embodiments of the invention.

Referring to back to FIGS. 1-3, according to one aspect of the present invention, liquid dispenser 200 is provided with a circulating working fluid (also referred to as a second liquid). As described above, liquid dispenser 200 includes a first liquid chamber 211 that is in fluid communication with a nozzle 220. A heater 230 is associated with a second liquid chamber 212. A flexible membrane 240 is positioned to separate and fluidically seal the first liquid chamber 211 and the second liquid chamber 212 from each other. A thermal actuator, for example, a heater 230, is located in a wall of second liquid chamber 212 opposite flexible membrane 240.

A liquid supply channel 251 is in fluid communication with second chamber 212 and a liquid return channel 252 is in fluid communication with second chamber 212. Liquid supply channel 251 and liquid return channel 252 are also in fluid communication with a liquid supply 255. During a drop ejection or dispensing operation, liquid supply 255 provides a liquid (commonly referred to as a working fluid or a working liquid) that flows continuously from liquid supply 255 through liquid supply channel 251 through second liquid chamber 212 through liquid return channel 252 and back to liquid supply 255. The circulating working fluid helps to increase the drop ejection frequency by removing at least some of the heat generated by heater 230 when it is actuated during drop ejection. The circulating working fluid can help increase the drop ejection frequency by pushing at least some of vapor bubble 260 off of and away from the heater 230 area as vapor bubble 260 collapses or increasing the speed of liquid replenishment relative to (over as shown in FIG. 2) heater 230.

A regulated pressure source 257 is positioned in fluid communication between liquid supply 255 and liquid supply channel 251. Regulated pressure source 257, for example, a pump, provides a positive pressure that is usually above atmospheric pressure. Optionally, a regulated vacuum supply 259, for example, a pump, can be included in order to better control liquid flow through second chamber 212. Typically, regulated vacuum supply 259 is positioned in fluid communication between liquid return channel 252 and liquid supply 255 and provides a vacuum (negative) pressure that is below atmospheric pressure. Liquid supply 255, regulated pressure source 257, and optional regulated vacuum supply 259 can be referred to as the liquid delivery system of liquid dispenser 200.

In one example embodiment, liquid supply 255 applies a positive pressure provided by a positive pressure source 257 at the entrance of liquid supply channel 251 and a negative pressure (or vacuum) provided by a negative pressure source 259 at the exit of liquid return channel 252. This helps to maintain the pressure inside second liquid chamber 212 at substantially the same pressure (for example, ambient pressure conditions) at the exit of nozzle 220 when the heater 230 is not energized. As a result, flexible membrane 240 is not deflected during a time period of drop dispensing when the heater 230 is not energized.

One advantage of heater 230 being positioned off axis relative to center axis A-A′ is that this location of heater 230 off-sets the asymmetric nature of the liquid flow through second liquid chamber 212. For example, when the heater 230 is placed to the left of center axis A-A′ of nozzle 220, the location of vapor bubble 260 at the time of maximum expansion is near or even on center axis A-A′ of nozzle 220 which helps causes increased deflection of flexible membrane 240.

Liquid is typically supplied to first chamber 211 in a manner similar to liquid chamber refill in a conventional drop on demand device. For example, during a drop dispensing operation using liquid dispenser 200, the liquid is not continuously flowing to first chamber 211 during a drop ejection or dispensing operation. Instead, first chamber 211 is refilled with liquid on an as needed basis that is made necessary by the ejection of a drop of the liquid from first chamber 211 through nozzle 220.

As flexible membrane 240 fluidically seals first chamber 211 and second chamber 212 from each other, first chamber 211 and second chamber 212 are physically distinct from each other which allows the first liquid and the second liquid present in each respective chamber to be different types of liquid when compared to each other in example embodiments of the invention. For example, the second liquid can include properties that increase its ability to remove heat while the second liquid can be an ink. The second liquid can include properties that lower its boiling point when compared to first liquid. The second liquid can include properties that make it a non-corrosive liquid, for example, nonionic liquid, in order to improve and maintain the functionality of heater 230 or increase its lifetime.

A high degree of flexibility in flexible membrane 240 is preferred to effectively transmit the pressure generated by vapor bubble 260 in the working fluid (a second liquid) to the fluid or liquid of interest (a first liquid), for example, ink, located in first chamber 211. In one example embodiment of the invention, this aspect of the invention is achieved by incorporating a bowed shape in a high modulus material membrane. The flexible membrane can be made out of high modulus materials such as alloys, metals, or dielectric materials, to meet fabrication requirements of mechanic strength, durability, or thinness of the flexible membrane. As the surface(s) of flexible membrane 240 is flat, an elastic material can be included with or substituted for a high modulus material during flexible membrane fabrication.

A high degree of flexibility in flexible membrane 240 is preferred to effectively transmit the pressure generated by vapor bubble 260 in the working fluid (a second liquid) to the fluid or liquid of interest (a first liquid), for example, ink, located in first chamber 211. Since flexible membrane 240 is flat, an elastic material can be included with or substituted for a high modulus material during flexible membrane fabrication.

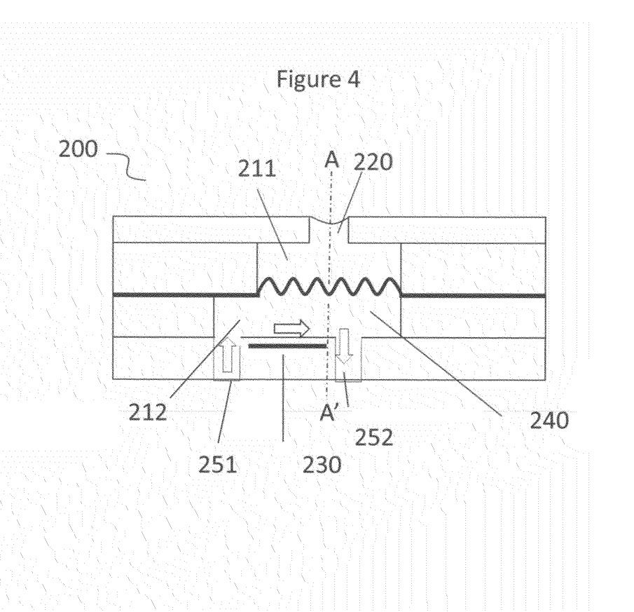

Referring to FIG. 4, another example embodiment of a liquid dispenser made in accordance with the present invention is shown. As shown in FIG. 4, flexible membrane 240 is corrugated when flexible membrane 240 is in an unactuated position or state (often referred to as an at rest position or state). The overall shape of flexible membrane 240 is planar in that flexible membrane is not bowed in a direction toward heater 230 or in a direction toward nozzle 220 when viewed, as shown in FIG. 4, from end to end of flexible membrane 240. The overall shape of flexible membrane 240 is symmetric relative to center axis A-A′ when viewed, as shown in FIG. 4, from end to end of flexible membrane 240. In alternative arrangements of this example embodiment of the invention, liquid dispenser 200 can be provided with a circulating working fluid as described above with reference to FIGS. 1-3.

A high degree of flexibility in flexible membrane 240 is preferred to effectively transmit the pressure generated by vapor bubble 260 in the working fluid (a second liquid) to the fluid or liquid of interest (a first liquid), for example, ink, located in first chamber 211. In one example embodiment of the invention, this aspect of the invention is achieved by incorporating a corrugated shape in a high modulus material membrane. The corrugated membrane can be made out of high modulus materials such as alloys, metals, or dielectric materials, to meet fabrication requirements of mechanic strength, durability, or thinness of the flexible membrane. These types of relatively strong materials may not have a high degree of elasticity, but the effect of the corrugation helps to greatly increase the membrane flexibility without requiring the use of an elastic material when compared to non-corrugated membranes.

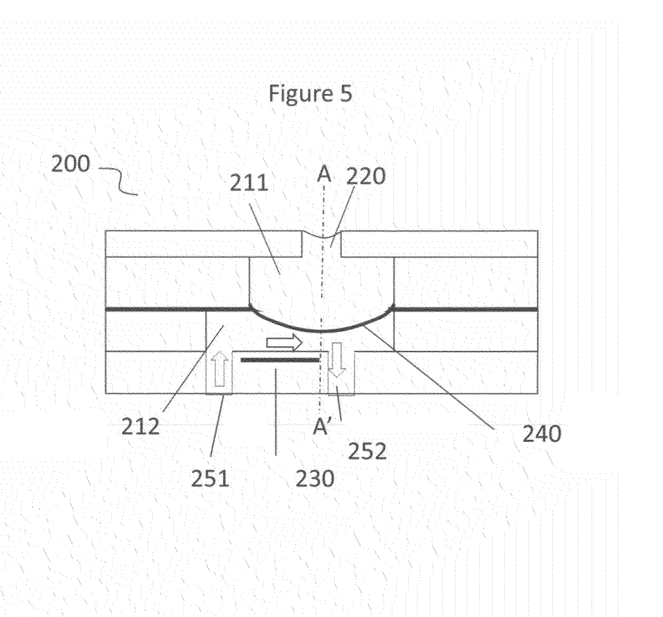

Referring to FIG. 5, another example embodiment of a liquid dispenser made in accordance with the present invention is shown. As shown in FIG. 5, flexible membrane 240 is attached to a side wall(s) 231 of liquid dispenser 200 to provide a fluidic seal and also to provide a mechanical constraint, for example, a compressive stress, that facilitates the snap-through behavior of flexible membrane 240. Flexible membrane 240 bows away from nozzle 220 when in an unactuated position or state (often referred to as an at rest position or state). The overall shape of flexible membrane 240 is concave relative to first chamber 211 or convex relative to second chamber 212 when viewed from end to end of flexible membrane 240 along a plane that separates first chamber 211 and second chamber 212 from each other. The overall shape of flexible membrane 240 is symmetric relative to center axis A-A′ when viewed, as shown in FIG. 5, from end to end of flexible membrane 240.

When unactuated or at rest, flexible membrane 240 is in a buckled equilibrium state. The pressure resulting from the expanding vapor bubble 260 produces a lateral force that pushes flexible membrane 240 and causes flexible membrane 240 to snap-through into another buckled equilibrium state. When in this equilibrium state, flexible membrane 240 is bowed in a direction toward nozzle 220. In this position, the overall shape of flexible membrane 240 is convex relative to first chamber 211 or concave relative to second chamber 212 when viewed from end to end of flexible membrane 240 along a plane that separates first chamber 211 and second chamber 212 from each other. The displacement of flexible membrane 240 pressurizes the liquid in the first liquid chamber 211 and ejects a liquid drop 270 through nozzle 220. In alternative arrangements of this example embodiment of the invention, liquid dispenser 200 can be provided with a circulating working fluid as described above with reference to FIGS. 1-3.

In the present invention, the flat flexible membrane shown in FIGS. 1 and 2, the corrugated flexible membrane shown in FIG. 4, and the buckled flexible membrane shown in FIG. 5 are sufficiently displaced as vapor bubble 260, created by actuation of heater 230, expands in second chamber 212. This displacement of the flexible membrane then displaces the liquid located in first chamber 211 resulting in efficient and reliable ejection of liquid drops though nozzle 220.

Liquid dispenser 200 is typically formed from a semiconductor material (for example, silicon) using semiconductor fabrication techniques (for example, CMOS circuit fabrication techniques, micro-electro mechanical structure (MEMS) fabrication techniques, or a combination of both). Alternatively, liquid dispenser 200 can be formed using conventional materials and fabrication techniques known in the art.

A liquid dispenser array structure made according to the present invention includes a plurality of liquid dispensers 200 described above with reference to FIGS. 1-4(c). The plurality of liquid dispensers 200 are formed, for example, integrally formed through a series of material layering and processing steps, on a common substrate typically using the fabrication techniques described above to create a monolithic liquid dispenser structure. When compared to other types of liquid dispensers, monolithic liquid dispenser configurations help to improve the alignment of each nozzle opening relative to other nozzle openings which improves drop deposition accuracy. Monolithic liquid dispenser configurations also help to reduce spacing in between adjacent nozzle openings which can increase the dots per inch (dpi) capability of the device.

The invention has been described in detail with particular reference to certain preferred embodiments thereof, but it will be understood that variations and modifications can be effected within the scope of the invention.

### PARTS LIST

200 a liquid dispenser
211 a first liquid chamber
212 a second liquid chamber
220 a nozzle
230 a heater
230a left side of a split heater
230b right side of a split heater
235 center point of a heater
240 a flexible membrane
251 a liquid supply channel
252 a liquid return channel
255 Liquid supply
257 Pressure source
259 Pressure source
260 a vapor bubble
270 a liquid drop

1. A liquid dispenser comprising:
a first liquid chamber including a nozzle, the nozzle including a center axis;
a second liquid chamber;
a liquid supply channel in fluid communication with the second chamber;
a liquid return channel in fluid communication with the second chamber;
a flexible membrane positioned to separate and fluidically seal the first liquid chamber and the second liquid chamber;
a liquid supply that provides a liquid that flows continuously from the liquid supply through the liquid supply channel through the second liquid chamber through the liquid return channel and back to the liquid supply;
a heater associated with the second liquid chamber, the heater including a center point, the heater being selectively actuated to create a pressure pulse in the liquid that causes the flexible membrane to move from a first position to a second position to eject liquid through the nozzle of the first liquid chamber, wherein the center point of the heater is located off of the center axis of the nozzle.

2. The liquid dispenser of claim 1, wherein the flexible membrane is corrugated.

3. The liquid dispenser of claim 1, the first liquid chamber including a first liquid and the second liquid chamber including a second liquid, wherein the first liquid and the second liquid are different liquids.

4. The liquid of dispenser of claim 3, wherein the second liquid has a lower boiling point when compared to the first liquid.

5. The liquid of dispenser of claim 3, wherein the second liquid is a non-corrosive liquid.

6. The liquid dispenser of claim 1, wherein the heater is a split heater.

7. The liquid dispenser of claim 1, the flexible membrane including a center point, wherein the center point of the flexible membrane is located on the center axis of the nozzle.

8. The liquid dispenser of claim 1, wherein the heater is a bubble jet type heater that creates the pressure pulse by vaporizing a portion of the liquid in the second chamber.
